(19) United States
(12) Patent Application Publication
(10) Pub. No.: US 2021/0237180 A1
(43) Pub. Date: Aug. 5, 2021

(54) METAL CUTTING CIRCULAR SAW

(71) Applicant: TANITEC CORPORATION, Tsuzuki-gun, Kyoto (JP)

(72) Inventor: Hiromitsu Ishikura, Tsuzuki-gun (JP)

(73) Assignee: TANITEC CORPORATION, Tsuzuki-gun, Kyoto (JP)

(21) Appl. No.: 16/311,250

(22) PCT Filed: Jun. 27, 2018
(86) PCT No.: PCT/JP2018/024294

§ 371 Date: Dec. 19, 2018

(30) Foreign Application Priority Data
Oct. 16, 2017 (JP) 2017-200222

(51) Int. Cl. B23D 61/04; B23D 65/00; B23P 15/28

(52) U.S. Cl. CPC B23D 61/04; B23P 15/28; B23D 65/00

(57) ABSTRACT

In a metal cutting circular saw, the cutting edge of a tip has an approximately recessed arc shape, and a recessed breaker portion is formed in a central portion of a rake face below the cutting edge and first side walls are provided on either side of the recessed breaker portion, and a cross-sectionally approximately recessed arc-shaped groove portion continuing to the recessed breaker portion is provided below the recessed breaker portion, second side walls continuing downward from the first side walls are formed on either side of the groove portion, and the second side walls are formed to have a width wider than the width of the first side walls so that angular portions are provided in an opposed manner in lower end portions of the respective first side walls, and the angular portions narrow the lower part of the recessed breaker portion.

### TECHNICAL FIELD

The present invention relates to a metal cutting circular saw used for cutting and various types of grinding work of a metal material such as a steel pipe.

### BACKGROUND ART

There has conventionally been known a metal cutting circular saw of this type in which multiple tips having the same height are arranged at a predetermined pitch on the outer periphery of a disk-shaped base metal, with notches for width tightening of chips formed at both ends of a flank face on the outer periphery of each tip and notches for division of chips formed in a central portion of the flank face.

In the circular saw, the notches for width tightening of chips have a width sufficient for widening of chips in the width direction and the notches for division have a sufficient depth with respect to the maximum thickness of the chips.

In addition, there has also been known a metal cutting circular saw in which saw blades are formed at predetermined intervals on the outer periphery of a disk-shaped base metal with tips securely attached to the respective saw blades, in which a groove for division of chips is formed in a flank face on the outer periphery of each tip and a taper-chamfered portion with a predetermined width is formed at an angular portion between the flank face on the outer periphery of each tip and a lateral flank face on either side of each tip. The taper-chamfered portion is then formed in a tapered manner expanding from a rake face side of the tip to the opposing direction.

As mentioned above, the conventional metal cutting circular saw generally has a groove for division of chips provided in a flank face on the outer periphery of each tip as means for processing chips generated during grinding of a workpiece material and, for resistance reduction during grinding, undergoes taper machining for reduction in impact resistance against the workpiece material and machining for reduction in contact area, for example, on the flank face and the lateral flank face or the outer periphery of each tip.

However, a high cutting edge strength has recently been required in grinding/cutting of, for example, bilayer stainless materials containing a large amount of Ni, Cr, and Mn and S13Cr materials for oil well pipes, with a problem that metal cutting circular saws having the above-mentioned structure cannot sufficiently accommodate this.

Also, if the workpiece material is a steel pipe, the surface of the steel pipe undergoes aluminum-added conventional galvanization to obtain particularly high corrosion-resistant characteristics, with a problem that the galvanized layer may be melted by grinding heat when the steel pipe is ground, chips adhered thereto are likely to adhere to the tips of the circular saw.

There has further been known a circular saw in which tips are threadably mounted on the pedestal of saw blades in an outer peripheral portion of a disk-shaped base metal, but the circular saw has a disadvantage that the strength of fixation of the tips is low and therefore the tips are likely to be damaged and fall off during use.

### SUMMARY OF INVENTION

It is hence an object of the present invention to solve the above-mentioned problems and disadvantages with conventional metal cutting circular saws at one time.

It is another object of the present invention to form chips in a shape suitable for emission as well as increase the grinding strength and abrasion-resistance of tips in grinding of such a workpiece material by a metal cutting circular saw.

It is a further object of the present invention to increase the emission performance of chips during grinding of a workpiece material to significantly improve the efficiency of grinding operations.

The present invention relates to a metal cutting circular saw and a method for manufacturing the same as follows.

That is, the present invention is directed mainly to a metal cutting circular saw in which saw blades are provided in a protruding manner at regular intervals on the outer periphery of a disk-shaped base metal and a tip is securely attached to a pedestal that is formed on a side surface of each of the saw blades in the rotation direction, in which the cutting edge of the tip has an approximately recessed arc shape, and in which a recessed breaker portion is formed in a central portion of a rake face below the cutting edge and first side walls are provided on either side of the recessed breaker portion, and in which a cross-sectionally approximately recessed arc-shaped groove portion continuing to the recessed breaker portion is provided below the recessed breaker portion, second side walls continuing downward from the first side walls are formed on either side of the groove portion, and the second side walls are formed to have a width wider than the width of the first side walls so that angular portions are provided in an opposed manner in lower end portions of the respective first side walls, and the angular portions narrow the lower part of the recessed breaker portion.

In another aspect of the present invention, the above-mentioned metal cutting circular saw is characterized in that the recessed breaker portion is formed in a mortar shape.

In a further aspect of the present invention, the above-mentioned metal cutting circular saw is characterized in that the ratio of the width of the first side walls to the blade width of the tip within the recessed breaker portion is within the range of 9 to 20% and the ratio of the depth of the breaker portion to the width of the first side walls is within the range of 6 to 18%.

In still another aspect of the present invention, the above-mentioned metal cutting circular saw is characterized in that the second side walls have upward inclined portions downward from the angular portions.

In a further aspect of the present invention, the metal cutting circular saw is characterized in that the second side walls have upward inclined portions downward from the angular portions and downward inclined portions downward from the upward inclined portions, to terminal portions of which the cross-sectionally approximately recessed arc-shaped groove portion continuing to the recessed breaker portion is formed.

In a still further aspect of the present invention, the metal cutting circular saw is characterized in that a recessed surface continuing to the second side walls is formed below the cross-sectionally approximately recessed arc-shaped groove portion continuing to the recessed breaker portion and the second side walls, and in which an approximately recessed arc-shaped chip guide portion corresponding to the groove portion is provided in an apex portion formed at the lower end of the recessed surface.

A method for manufacturing the above-described metal cutting circular saw according to the present invention includes: a molding step of sintering and molding a tip original form; a forming step of polishing and forming the sintered and molded form into a breaker portion-accompanied tip; a coating step of applying physical vapor deposition or chemical vapor deposition onto the surface of the polished and formed breaker portion-accompanied tip, so that the breaker portion-accompanied tip is finished; and thereafter, a fitting step of fitting the finished breaker portion-accompanied tip into a pedestal of a base metal; and a joining step of securely attaching the fitted breaker portion-accompanied tip to the pedestal.

Another method for manufacturing the metal cutting circular saw according to the present invention includes: a molding step of sintering and molding a tip original form; a fitting step of fitting the sintered and molded form into a pedestal of a base metal; a joining step of securely attaching the fitted form to the pedestal; a forming step of polishing and forming the joined form into a breaker portion-accompanied tip; and a coating step of applying physical vapor deposition or chemical vapor deposition onto the surface of the polished and formed tip.

In a further aspect of the present invention, during the joining step in each method for manufacturing the metal cutting circular saw, the base metal and a brazing heat source coil are directly adjacent to each other at the base metal side, while a cooling medium is interposed between the breaker portion-accompanied tip and the brazing heat source coil at the breaker portion-accompanied tip side.

In grinding/cutting of a workpiece material by the metal cutting circular saw having the above-mentioned structure according to the present invention, first, the recessed breaker portion formed in the central portion of the rake face continuing downward from the recessed arc-shaped cutting edge cuts concavely into the surface of the workpiece material, during which the first side walls provided in a protruding manner on either side of the recessed breaker portion allows the cutting edge to firmly and reliably catch the workpiece surface without weaving, and concave chips are generated.

Next, during cut-in by the recessed arc-shaped groove portion of the tip, the angular portions at the boundary between the groove portion and the recessed breaker portion start new cut-in narrower than the recessed breaker portion, and then the recessed arc-shaped groove portion causes the side portions of the concave chips generated by the recessed breaker portion to stand up and thereby the chips have a slightly spirally curled form to be emitted easily from the gullet of the circular saw. Chips generated through a series of cut-in by the thus arranged recessed breaker portion and the recessed arc-shaped groove portion formed in a manner continuing thereto are also emitted smoothly without weaving laterally by the first side walls and the second side walls continuing thereto in a stably straight curled form.

Also, in grinding/cutting of a workpiece material by the metal cutting circular saw additionally having the chip guide portion according to the above-mentioned aspect of the present invention, chips can be emitted further stably by the chip guide portion.

Further, in accordance with the metal cutting circular saw with the upward inclined portions and the downward inclined portions continuing thereto provided in the second side walls according to the above-mentioned aspect of the present invention, the presence of the downward inclined portions continuing to the upward inclined portions allows for grinding/cutting with a space ensured constantly between the tip and the workpiece material, which can provide a thermolytic action to suppress the temperature rise of the ground portion.

In addition, in accordance with the above-mentioned method for manufacturing a metal cutting circular saw according to the present invention, tips are only required to preliminarily and individually undergo sintering and molding of an original form through finishing by the final surface coating and then collectively and securely attached to the pedestals of the respective saw blades, whereby the manufacturing operation and cost can be reduced significantly compared to conventional throw-away tip saws. The strength of fixation of the tips to the pedestals can also be ensured sufficiently.

Furthermore, during the joining step in the manufacturing method, if the base metal and the brazing heat source coil are directly adjacent to each other at the base metal side, while a cooling medium is interposed between the breaker portion-accompanied tip and the brazing heat source coil at the breaker portion-accompanied tip 5 side, the pedestal portion can be heated locally while the breaker portion-accompanied tip itself is prevented from undergoing an excessive temperature rise.

### BRIEF DESCRIPTION OF DRAWINGS

FIG. 1 is a front view showing a portion of the outer periphery of a metal cutting circular saw according to an embodiment of the present invention.

FIG. 2 is an enlarged perspective view of a saw blade portion in the circular saw according to the embodiment.

FIG. 3 is an enlarged perspective view of a tip on a pedestal in the circular saw according to the embodiment.

FIG. 4 is a flowchart showing a process of manufacturing the circular saw according to the embodiment.

FIG. 5 is a perspective view of a saw blade portion shewing how to join a tip in a method for manufacturing the circular saw according to the embodiment.

FIG. 6 is an enlarged front view of the saw blade portion showing an operation of joining the tip in the circular saw according to the embodiment.

FIG. 7 is an enlarged view showing the relationship between the blade width and the first side wall width as well as the breaker depth in the tip of the circular saw according to the embodiment.

FIG. 8 is a graph showing, as a grinding performance, the relationship between the blade width WL and the first side wall width FL as well as the breaker depth DL in the tip of the circular saw according to the embodiment.

FIG. 9 is a flowchart showing another process of manufacturing the circular saw according to the embodiment.

FIG. 10 shows results of a grinding performance test conducted to the examples.

### DESCRIPTION OF EMBODIMENTS

An embodiment of the present invention will hereinafter be described with reference to the accompanying drawings, however, the present invention is not limited to the embodiment.

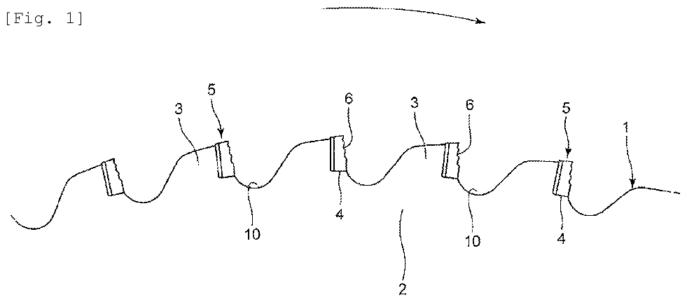

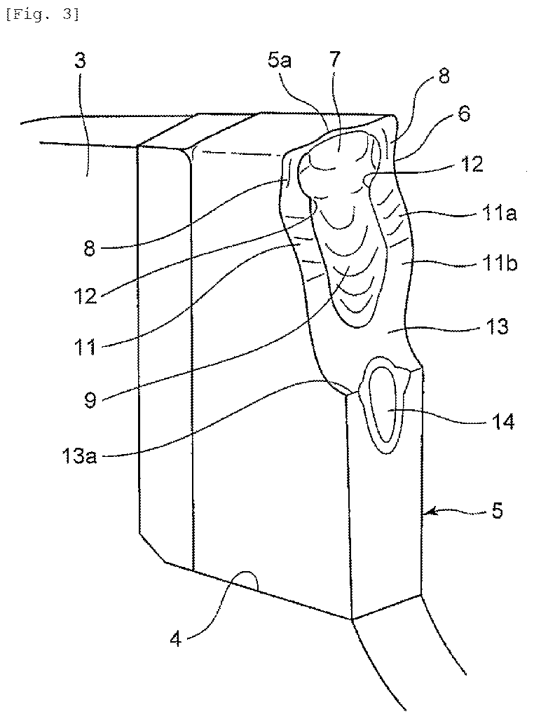

As shown in FIGS. 1 to 3, a metal cutting circular saw 1 according to this embodiment is arranged such that saw blades 3 are provided in a protruding manner at regular intervals on the outer periphery of a disk-shaped base metal 2 and a tip 5 is securely attached to a pedestal 4 that is formed on a side surface of each of the saw blades 3 in the rotation direction (arrow direction).

In the metal cutting circular saw 1 according to this embodiment, the cutting edge 5a of the tip 5 then has an approximately recessed arc shape, and a recessed breaker portion 7 is formed in a central portion of a rake face 6 below the cutting edge 5a and first side walls 8 are provided on either side of the recessed breaker portion 7, a cross-sectionally approximately recessed arc-shaped groove portion 9 continuing to the recessed breaker portion 7 is provided below the recessed breaker portion 7, and second side walls 11 continuing downward from the first side walls 8 are formed on either side of the groove portion 7. The second side walls 11 are formed to have a width wider than the width of the first side walls 8 so that angular portions 12 are provided in an opposed manner in lower end portions of the respective first side walls 8, and the angular portions 12 narrow the lower part of the recessed breaker portion 1.

In this embodiment, the recessed breaker portion 7 is formed in a mortar shape. Also, the second side walls 11 have upward inclined portions 11a downward from the angular portions 12 and downward inclined portions 11b downward from the upward inclined portions 11a, to terminal portions of which the groove portion 9 is formed.

Further, in this embodiment, a recessed surface 13 continuing to the second side walls 11 is formed below the groove portion 9 and the second side walls 11, and a cross-sectionally approximately recessed arc-shaped chip guide portion 14 corresponding to the groove portion 9 is provided in an apex portion 13a formed at the lower end of the recessed surface 13.

In accordance with the metal cutting circular saw 1 having the above-mentioned structure according to this embodiment, first, the recessed breaker portion 7 formed in the central portion of the rake face 6 continuing downward from the approximately recessed arc-shaped cutting edge 5a cuts concavely into the surface of the workpiece material, during which the first side walls 8 provided in a protruding manner on either side of the recessed breaker portion 7 allows the cutting edge 5a to firmly and reliably catch the workpiece surface without weaving, and concave chips are generated.

Next, during cut-in by the recessed arc-shaped groove portion 9 of the tip 5, the angular portions 12 at the boundary between the groove portion 9 and the recessed breaker portion 7 start new cut-in narrower than the recessed breaker portion 7, and then the recessed arc-shaped groove portion 9 causes the side portions of the concave chips generated by the recessed breaker portion 7 to stand up and thereby the chips CP to have a slightly spirally curled form to be emitted easily from the gullet 10 of the circular saw 1.

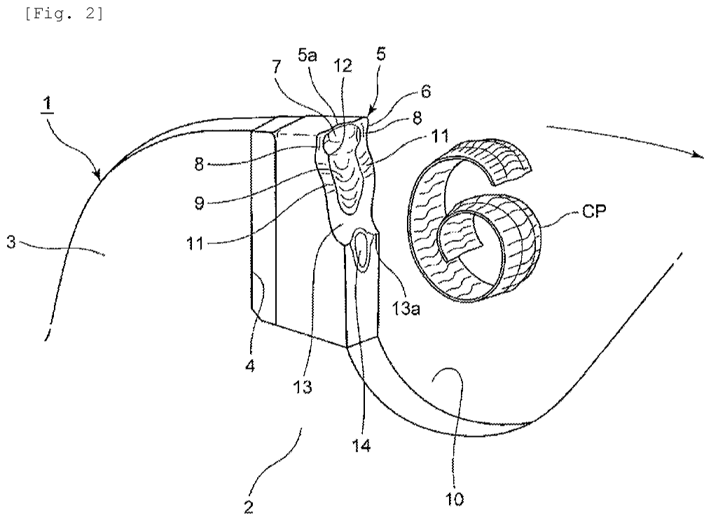

That is, as shown in FIG. 2, a series of grinding as mentioned above on the workpiece material by the metal cutting circular saw 1 according to this embodiment causes the chips CP to have a slightly spirally curled form. The chips generated through a series of cut-in by the recessed breaker portion 7 and the recessed arc-shaped groove portion 9 formed in a manner continuing thereto are also emitted smoothly without weaving laterally by the first side walls 8 and the second side walls 11 continuing thereto in a stably straight curled form.

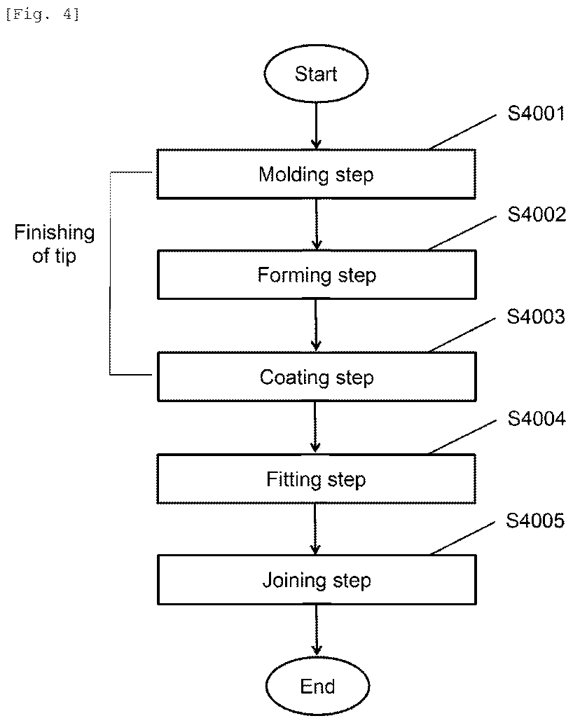

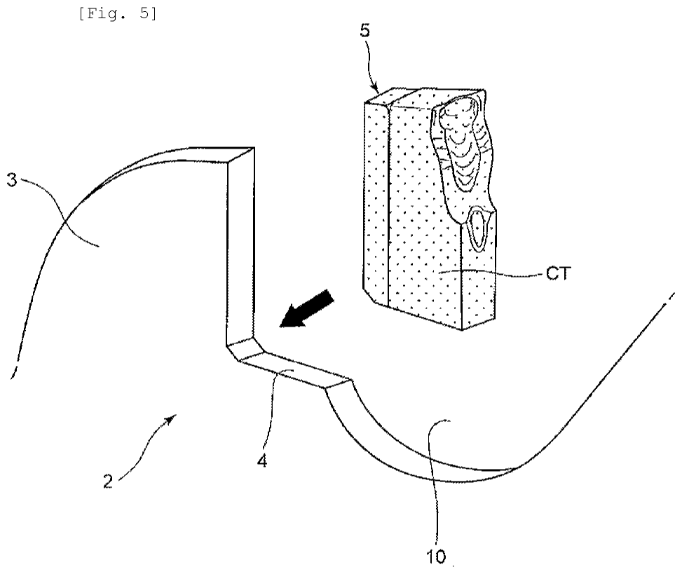

Next will be described a method for manufacturing the above-mentioned metal cutting circular saw 1 according to this embodiment, as shown in FIGS. 4 and 5. As mentioned above, the metal cutting circular saw 1 is arranged such that saw blades 3 are provided in a protruding manner at regular intervals on the outer periphery of a disk-shaped base metal 2 and, through brazing, a tip 5 is securely and integrally attached to a pedestal 4 that is formed on a side surface of each of the saw blades 3 in the rotation direction. Then, in this embodiment, the base metal 2 is made of carbon tool steel or alloy tool steel, and the tip 5 is made of cemented carbide, cermet, or high-speed tool steel, the surface of which is applied with coating CT through physical vapor deposition or chemical vapor deposition such as PVD or CVD in the procedures to be described below.

The method for manufacturing the metal cutting circular saw 1 then includes a molding step (S4001) of sintering and molding an original form of the tip 5, a forming step (S4002) of polishing and forming the sintered and molded form into a breaker portion-accompanied tip 5, a coating step (S4003) of applying physical vapor deposition or chemical vapor deposition such as PVD or CVD onto the surface of the polished and formed breaker portion-accompanied tip 5, so that the breaker portion-accompanied tip 5 is finished, and thereafter, a fitting step (S4004) of fitting the finished breaker portion-accompanied tip 5 into the pedestal 4 of the base metal 2, and a joining step (S4005) of brazing the fitted breaker portion-accompanied tip 5 to the pedestal 4.

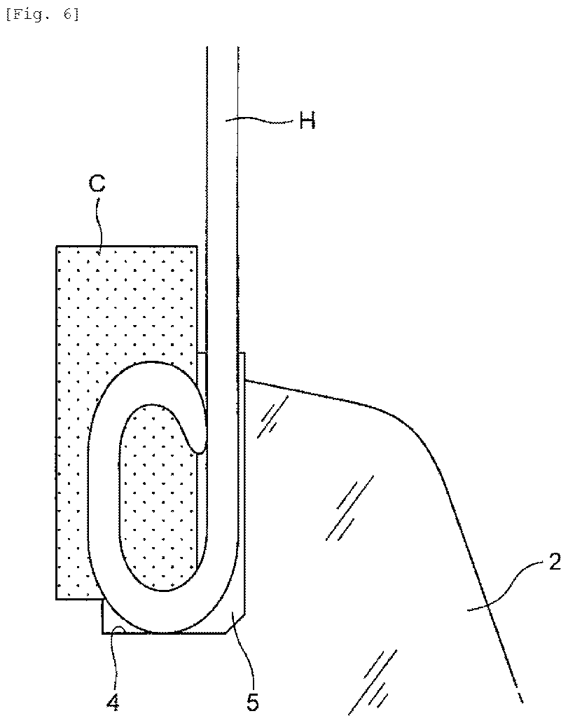

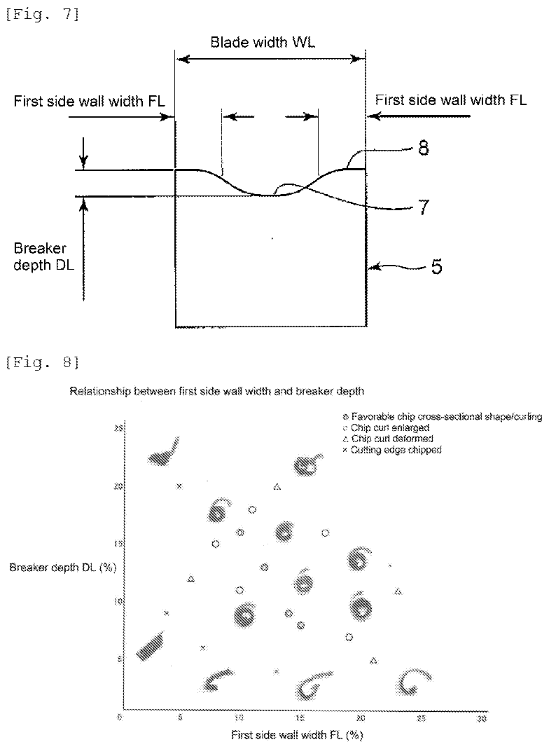

Also, as shown in FIG. 6, during the joining step (S4005), the base metal 2 and a brazing heat source coil H are directly adjacent to each other at the base metal 2 side, while a cooling medium C is interposed between the breaker portion-accompanied tip 5 and the brazing heat source coil H at the breaker portion-accompanied tip 5 side, whereby the pedestal portion 4 can be heated locally while the breaker portion-accompanied tip 5 itself is prevented from undergoing an excessive temperature rise.

It is noted that in the present invention, the arrangement of the cooling medium is not particularly limited, but the cooling medium C may have, for example, a hollow box shape or a box-shaped structure with a passage formed therein through which water, compressed air, cooling nitrogen, etc., flows.

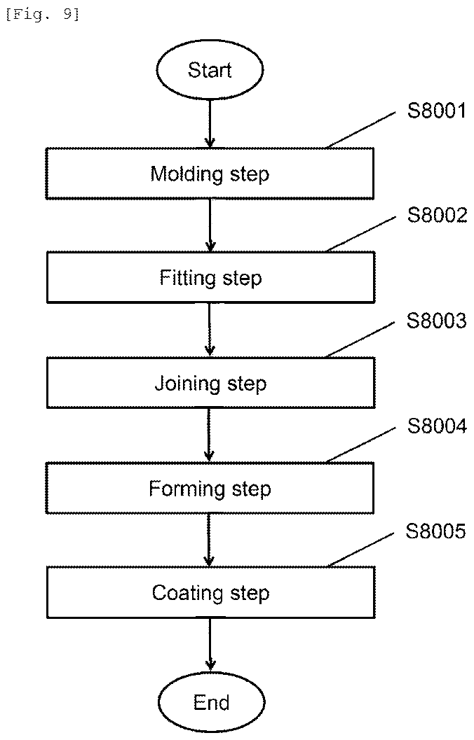

Also, as shown in FIG. 8, another method for manufacturing the thus structured metal cutting circular saw 1 different from the above-mentioned manufacturing method illustrated in FIG. 4 includes a molding step (S8001) of sintering and molding a tip original form, a fitting step (S8002) of fitting the sintered and molded form into the pedestal of the base metal, a joining step (S8003) of securely attaching the fitted form to the pedestal, a forming step (S8004) of polishing and forming the joined form into a breaker portion-accompanied tip, and a coating step (S8005) of applying physical vapor deposition or chemical vapor deposition onto the surface of the polished and formed tip.

### (Grinding Performance Test)

Next will be described a grinding performance test conducted to compare the 3D breaker-bladed circular saw 1 according to the present invention with a conventionally-bladed metal cutting circular saw not having the breaker portion 7, the groove portion 9, the chip guide portion 14, etc., as in the circular saw 1.

Specifically, the saw blade specification was HM630×6.0 (5.0)×80H×48Z for both of the circular saws, and the workpiece material was a solid 13Cr material (high hardness material) of φ170 mm. The cutting conditions then include a saw blade circumferential speed of 80 m/min, a feed rate of 172 mm/min, and a one-blade cut-in amount of 0.09 mm/blade.

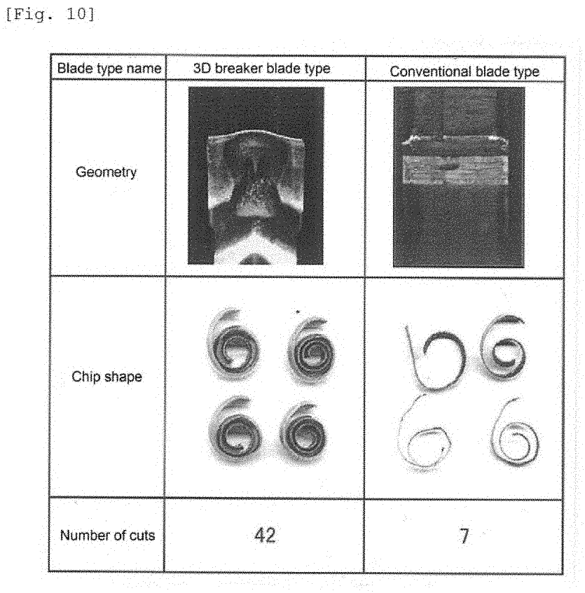

Results of the above-mentioned grinding performance test are shown in FIG. 10 below.

That is, all chips had a slightly curled constant shape with the 3D breaker blade type according to the present invention, while with the conventional blade type, chips had an irregular and larger curled shape compared to the case of the 3D breaker blade type according to the present invention. The number of cuts on the workpiece material was then 42 with the 3D breaker blade type according to the present invention, while 7 with the conventional blade type, demonstrating that the blade type according to the present invention has six times as long a lifetime. Such a noticeable difference in grinding/cutting using the circular saw of the 3D breaker blade type according to the present invention and the circular saw of the conventional blade type is due to the fact that, as mentioned above, chips from the workpiece material had a non-constant and slightly larger irregularly curled shape with the conventional blade type. This may be caused by the fact that grinding with the conventional blade type was unstable and chips were not emitted smoothly from the gullet during grinding/cutting, and the remaining chips were sandwiched between the cutting edge and the workpiece material, whereby chipping from the cutting edge portion resulted in a lifetime reduction.

On the other hand, as mentioned above, all chips had a slightly curled constant favorable shape with the 3D breaker blade type according to the present invention. It may be recognized that this is because favorable grinding was made stably as mentioned above with the 3D breaker blade type according to the present invention and, as a result, unlike the conventional blade type, chips were emitted smoothly from the gullet without being stuck and therefore no chipping occurred on the cutting edge.

Also, as shown in FIG. 7, a verification test was conducted on the relationship between the blade width WL and the width FL of the first side walls 8 as well as the relationship between the width FL of the first side walls 8 and the depth DL of the recessed breaker portion 7 in the breaker portion 7 of the rake face 6 of the tip 5 for the 3D breaker blade type according to the present invention. The results are as shown in FIG. 8, in which favorable grinding results were obtained when the depth DL of the breaker portion 7 was within the range of 6 to 18%, and also favorable grinding results were obtained when the width FL of the first side walls 8 side was within the range of 9 to 20%.

1. A metal cutting circular saw in which saw blades are provided in a protruding manner at regular intervals on the outer periphery of a disk-shaped base metal and a tip is securely attached to a pedestal that is formed on a side surface of each of the saw blades in the rotation direction, wherein the cutting edge of the tip has an approximately recessed arc shape, and wherein a recessed breaker portion is formed in a central portion of a rake face below the cutting edge and first side walls are provided on either side of the recessed breaker portion, and wherein a cross-sectionally approximately recessed arc-shaped groove portion continuing to the recessed breaker portion is provided below the recessed breaker portion, second side walls continuing downward from the first side walls are formed on either side of the groove portion, and the second side walls are formed to have a width wider than the width of the first side walls so that angular portions are provided in an opposed manner in lower end portions of the respective first side walls, the angular portions narrowing the lower part of the recessed breaker portion.

2. The metal cutting circular saw according to claim 1, wherein the recessed breaker portion is formed in a mortar shape.

3. The metal cutting circular saw according to claim 1, wherein the ratio of the width of the first side walls to the blade width of the tip within the recessed breaker portion is within the range of 9 to 20% and the ratio of the depth of the breaker portion to the width of the first side walls is within the range of 6 to 18%.

4. The metal cutting circular saw according to claim 1, wherein the second side walls have upward inclined portions downward from the angular portions.

5. The metal cutting circular saw according to claim 4, wherein the second side walls have upward inclined portions downward from the angular portions and downward inclined portions downward from the upward inclined portions, to terminal portions of which the cross-sectionally approximately recessed arc-shaped groove portion continuing to the recessed breaker portion is formed.

6. The metal cutting circular saw according to claim 5, wherein a recessed surface continuing to the second side walls is formed below the cross-sectionally approximately recessed arc-shaped groove portion continuing to the recessed breaker portion and the second side walls, and wherein an approximately recessed arc-shaped chip guide portion corresponding to the groove portion is provided in an apex portion formed at the lower end of the recessed surface.

7. A method for manufacturing a metal cutting circular saw according to claim 1, comprising: a molding step of sintering and molding a tip original form; a forming step of polishing and forming the sintered and molded form into a breaker portion-accompanied tip; a coating step of applying physical vapor deposition or chemical vapor deposition onto the surface of the polished and formed breaker portion-accompanied tip, so that the breaker portion-accompanied tip is finished; and thereafter, a fitting step of fitting the finished breaker portion-accompanied tip into a pedestal of a base metal; and a joining step of securely attaching the fitted breaker portion-accompanied tip to the pedestal.

8. A method for manufacturing a metal cutting circular saw according to claim 1, comprising: a molding step of sintering and molding a tip original form; a fitting step of fitting the sintered and molded form into a pedestal of a base metal; a joining step of securely attaching the fitted form to the pedestal; a forming step of polishing and forming the joined form into a breaker portion-accompanied tip; and a coating step of applying physical vapor deposition or chemical vapor deposition onto the surface of the polished and formed tip.

9. The method for manufacturing a metal cutting circular saw according to claim 7, wherein, during the joining step, the base metal and a brazing heat source coil are directly adjacent to each other at the base metal side, while a cooling medium is interposed between the breaker portion-accompanied tip and the brazing heat source coil at the breaker portion-accompanied tip side.
